(19) United States
(12) Patent Application Publication
(10) Pub. No.: US 2018/0084407 A1
(43) Pub. Date: Mar. 22, 2018

(54) METHOD FOR TRANSMITTING SIDELINK TERMINAL INFORMATION OF TERMINAL IN WIRELESS COMMUNICATION SYSTEM AND TERMINAL UTILIZING THE METHOD

(71) Applicant: LG ELECTRONICS INC., Seoul (KR)

(72) Inventors: Sunghoon Jung, Seoul (KR); Jaewook Lee, Seoul (KR)

(21) Appl. No.: 15/564,148

(22) PCT Filed: Apr. 8, 2016
(86) PCT No.: PCT/KR2016/003738

§ 371 Date: Oct. 3, 2017

Related U.S. Application Data
(60) Provisional application No. 62/144,343, filed on Apr. 8, 2015.

(51) Int. Cl. H04W 8/24; H04W 72/04

(52) U.S. Cl. CPC H04W 8/24; H04W 76/043; H04W 72/0406; H04W 72/048

(57) ABSTRACT

Provided are a method for transmitting sidelink terminal information of a terminal in a wireless communication system and a terminal utilizing the method. The method determines a cell to carry out a proximity-based service (Prose) action, and transmits, to a network, sidelink terminal information comprising information for identifying the cell.

### CROSS-REFERENCE TO RELATED APPLICATIONS

This application is the National Stage filing under 35 U.S.C. 371 of International Application No. PCT/KR2016/003738, filed on Apr. 8, 2016, which claims the benefit of U.S. Provisional Application No. 62/144,343 filed on Apr. 8, 2015, the contents of which are all hereby incorporated by reference herein in their entirety.

### BACKGROUND OF THE INVENTION

### Field of the Invention

The present invention relates to wireless communication, and more particularly, to a method for transmitting sidelink terminal information of a terminal in a wireless communication system and a terminal utilizing the method.

### Related Art

The International Telecommunication Union Radio Communication Sector (ITU-R) is conducting a standardization operation of International Mobile Telecommunication (IMT)-Advanced which is a next-generation mobile communication system after 3rd generation. The IMT-Advanced aims to support IP (Internet Protocol) based multimedia service at data rate of 1 Gbps in stationary and low-speed moving states and 100 Mbps in a high-speed moving state.

The 3rd Generation Partnership Project (3GPP) as a system standard that meets the requirements of the IMT-Advanced prepares for LTE-Advanced (LTE-A) created by improving Long Term Evolution (LTE) based on Orthogonal Frequency Division Multiple Access (OFDMA)/Single Carrier-Frequency Division Multiple Access (SC-FDMA). The LTE-A is one of the strong candidates for the IMT-Advanced.

In recent years, there has been a growing interest in device-to device (D2D) technology for direct communication between devices. In particular, the D2D has attracted attention as communication technology for a public safety network. Commercial communication networks are rapidly changing to LTE, but current public safety networks are mainly based on 2G technology in terms of conflicts with existing communication standards and cost. The technological gaps and demands for improved services have led to efforts to improve the public safety networks.

The public safety networks have higher service requirements (reliability and security) than the commercial communication networks and require direct signal transmission and reception, or D2D operation, between the devices, particularly when coverage of cellular communications is insufficient or unavailable.

A D2D operation can have various advantages in that the D2D operation is signal transmission/reception between neighboring devices. For example, a D2D terminal has high data rate and low latency and is capable of data communication. In addition, the D2D operation can distribute traffic which concentrates on a base station and can also serve to expand the coverage of the base station if the D2D terminal serves as a repeater.

In the LTE-A, a terminal-to-terminal interface is referred to as a sidelink. Operations which can be performed by the terminal include sidelink communication and sidelink discovery.

In the related art, it is assumed that the terminal continuously transmits a sidelink discovery signal only in a serving cell and receives even a configuration for the sidelink discovery signal only in the serving cell. However, in a future wireless communication system, the terminal may transmit the sidelink discovery signal in a non-serving cell of a non-serving frequency not receiving the service.

The terminal informs the network of information on the sidelink through the sidelink terminal information. In the sidelink terminal information, the terminal cannot inform a frequency or cell which the terminal is interested in transmitting the sidelink discovery signal. Therefore, it is inefficient to directly apply the sidelink terminal information in the related art to the future wireless communication systems as it is.

### SUMMARY OF THE INVENTION

The present invention provides a method for transmitting sidelink terminal information of a terminal in a wireless communication system and a terminal utilizing the method.

In an aspect, a method for transmitting sidelink UE information of a UE in a wireless communication system is provided. The method may comprise deciding a cell which intends to perform a proximity based services (ProSe) operation and transmitting sidelink UE information including information to identify the cell to a network.

The cell may be a cell positioned in a non-primary frequency for the UE.

When the cell is a secondary serving cell, the information to identify the cell may be a serving cell index or a physical cell identity (ID) of the cell.

When the cell is a non-serving cell, the information to identify the cell may be constituted by a frequency of the cell and the physical cell identity (ID) of the cell.

When the cell which intends to perform the ProSe operation is the non-serving cell positioned in the non-serving frequency for the UE, the UE may transmit information for announcing the frequency of the non-serving cell and the physical cell ID of the non-serving cell included in the sidelink UE information.

When the cell which intends to perform the ProSe operation is the non-serving cell positioned in the serving frequency for the UE, the UE may transmit information for announcing the frequency of the serving cell and the physical cell ID of the non-serving cell included in the sidelink UE information.

When the cell which intends to perform the ProSe operation is the non-serving cell positioned in the serving frequency for the UE, the UE may transmit the information for announcing the frequency of the serving cell or the physical cell ID of the non-serving cell included in the sidelink UE information.

A ProSe configuration for the cell may be received from the network.

The UE may perform the ProSe operation based on the ProSe configuration.

In another aspect, a user equipment (UE) is provided. The UE may comprise a radio frequency (RF) unit transmitting and receiving a radio signal and a processor operated in association with the RF unit, wherein the processor decide a cell in which the UE intends to perform a proximity based services (ProSe) operation, and transmits sidelink UE information including information to identify the cell to a network.

According to the present invention, a frequency and a cell at which a terminal is interested in transmitting a discovery signal can be notified to a network through sidelink terminal information. Therefore, the network can prevent uplink scheduling for the terminal from a conflict with the transmission of the discovery signal by the terminal during the uplink scheduling for the terminal. As a result, performance degradation of the transmission of the discovery signal by the terminal can be prevented.

### BRIEF DESCRIPTION OF THE DRAWINGS

FIG. 1 shows a wireless communication system to which the present invention is applied.

FIG. 2 is a diagram showing a wireless protocol architecture for a user plane.

FIG. 3 is a diagram showing a wireless protocol architecture for a control plane.

FIG. 4 is a flowchart illustrating the operation of UE in the RRC idle state.

FIG. 5 is a flowchart illustrating a procedure of establishing RRC connection.

FIG. 6 is a flowchart illustrating an RRC connection reconfiguration procedure.

FIG. 7 is a diagram illustrating an RRC connection re-establishment procedure.

FIG. 8 illustrates sub states where the terminal may have in an RRC_IDLE state and a sub state transition process.

FIG. 9 illustrates a reference structure for a ProSe.

FIG. 10 illustrates arrangement examples of terminals performing ProSe direct communication and cell coverage.

FIG. 11 illustrates a user plane protocol stack for the ProSe direct communication.

FIG. 12 illustrates a PC 5 interface for D2D discovery.

FIG. 13 illustrates an embodiment of a ProSe direct discovery process.

FIG. 14 illustrates another embodiment of the ProSe direct discovery process.

FIG. 15 illustrates one example in which the UE transmits the discovery signal in a future wireless communication system.

FIG. 16 illustrates a method for transmitting sidelink UE information of a UE according to an embodiment of the present invention.

FIG. 17 illustrates a method for transmitting sidelink UE information of a UE according to an embodiment of the present invention.

FIG. 18 illustrates a method for transmitting sidelink UE information of a UE according to another embodiment of the present invention.

FIG. 19 is a block diagram illustrating a UE in which the embodiment of the present invention is implemented.

### DESCRIPTION OF EXEMPLARY EMBODIMENTS

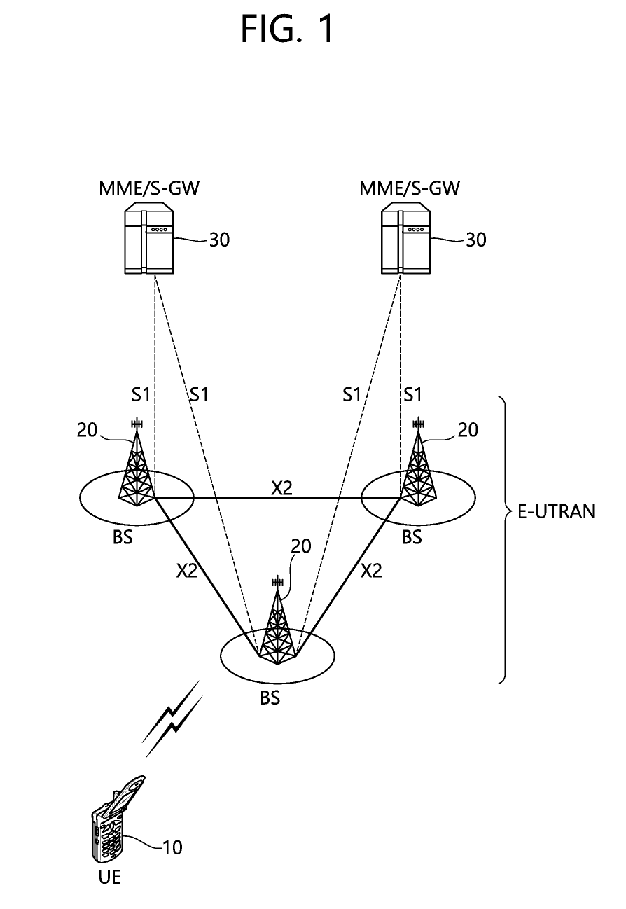

FIG. 1 shows a wireless communication system to which the present invention is applied. The wireless communication system may also be referred to as an evolved-UMTS terrestrial radio access network (E-UTRAN) or a long term evolution (LTE)/LTE-A system.

The E-UTRAN includes at least one base station (BS) 20 which provides a control plane and a user plane to a user equipment (UE) 10. The UE 10 may be fixed or mobile, and may be referred to as another terminology, such as a mobile station (MS), a user terminal (UT), a subscriber station (SS), a mobile terminal (MT), a wireless device, etc. The BS 20 is generally a fixed station that communicates with the UE 10 and may be referred to as another terminology, such as an evolved node-B (eNB), a base transceiver system (BTS), an access point, etc.

The BSs 20 are interconnected by means of an X2 interface. The BSs 20 are also connected by means of an S1 interface to an evolved packet core (EPC) 30, more specifically, to a mobility management entity (MME) through S1-MME and to a serving gateway (S-GW) through S1-U.

The EPC 30 includes an MME, an S-GW, and a packet data network-gateway (P-GW). The MME has access information of the UE or capability information of the UE, and such information is generally used for mobility management of the UE. The S-GW is a gateway having an E-UTRAN as an end point. The P-GW is a gateway having a PDN as an end point.

Layers of a radio interface protocol between the UE and the network can be classified into a first layer (L1), a second layer (L2), and a third layer (L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

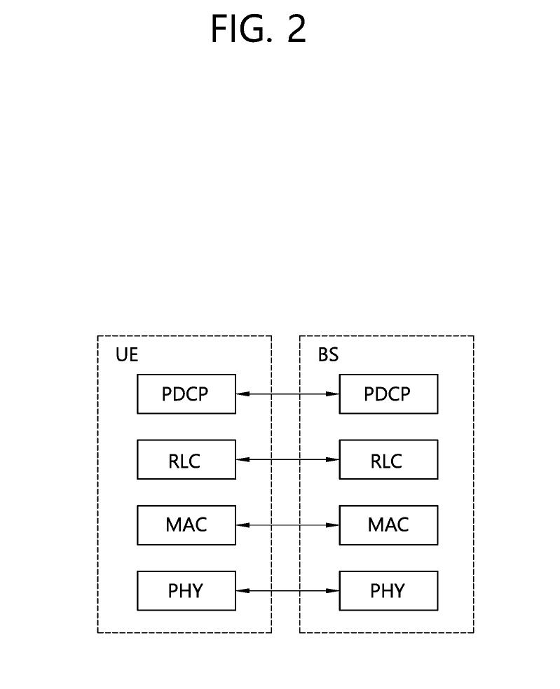

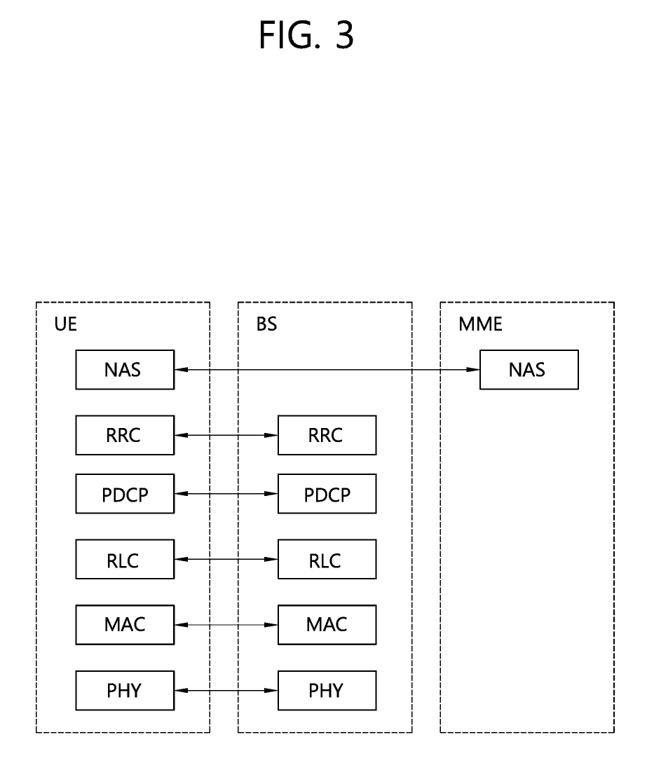

FIG. 2 is a diagram showing a wireless protocol architecture for a user plane. FIG. 3 is a diagram showing a wireless protocol architecture for a control plane. The user plane is a protocol stack for user data transmission. The control plane is a protocol stack for control signal transmission.

Referring to FIGS. 2 and 3, a PHY layer provides an upper layer with an information transfer service through a physical channel. The PHY layer is connected to a medium access control (MAC) layer which is an upper layer of the PHY layer through a transport channel. Data is transferred between the MAC layer and the PHY layer through the transport channel. The transport channel is classified according to how and with what characteristics data is transferred through a radio interface.

Data is moved between different PHY layers, that is, the PHY layers of a transmitter and a receiver, through a physical channel. The physical channel may be modulated according to an Orthogonal Frequency Division Multiplexing (OFDM) scheme, and use the time and frequency as radio resources.

The functions of the MAC layer include mapping between a logical channel and a transport channel and multiplexing and demultiplexing to a transport block that is provided through a physical channel on the transport channel of a MAC Service Data Unit (SDU) that belongs to a logical channel. The MAC layer provides service to a Radio Link Control (RLC) layer through the logical channel.

The functions of the RLC layer include the concatenation, segmentation, and reassembly of an RLC SDU. In order to guarantee various types of Quality of Service (QoS) required by a Radio Bearer (RB), the RLC layer provides three types of operation mode: Transparent Mode (TM), Unacknowledged Mode (UM), and Acknowledged Mode (AM). AM RLC provides error correction through an Automatic Repeat Request (ARQ).

The RRC layer is defined only on the control plane. The RRC layer is related to the configuration, reconfiguration, and release of radio bearers, and is responsible for control of logical channels, transport channels, and PHY channels. An RB means a logical route that is provided by the first layer (PHY layer) and the second layers (MAC layer, the RLC layer, and the PDCP layer) in order to transfer data between UE and a network.

The function of a Packet Data Convergence Protocol (PDCP) layer on the user plane includes the transfer of user data and header compression and ciphering. The function of the PDCP layer on the user plane further includes the transfer and encryption/integrity protection of control plane data.

What an RB is configured means a procedure of defining the characteristics of a wireless protocol layer and channels in order to provide specific service and configuring each detailed parameter and operating method. An RB can be divided into two types of a Signaling RB (SRB) and a Data RB (DRB). The SRB is used as a passage through which an RRC message is transmitted on the control plane, and the DRB is used as a passage through which user data is transmitted on the user plane.

If RRC connection is established between the RRC layer of UE and the RRC layer of an E-UTRAN, the UE is in the RRC connected state. If not, the UE is in the RRC idle state.

A downlink transport channel through which data is transmitted from a network to UE includes a broadcast channel (BCH) through which system information is transmitted and a downlink shared channel (SCH) through which user traffic or control messages are transmitted. Traffic or a control message for downlink multicast or broadcast service may be transmitted through the downlink SCH, or may be transmitted through an additional downlink multicast channel (MCH). Meanwhile, an uplink transport channel through which data is transmitted from UE to a network includes a random access channel (RACH) through which an initial control message is transmitted and an uplink shared channel (SCH) through which user traffic or control messages are transmitted.

Logical channels that are placed over the transport channel and that are mapped to the transport channel include a broadcast control channel (BCCH), a paging control channel (PCCH), a common control channel (CCCH), a multicast control channel (MCCH), and a multicast traffic channel (MTCH).

The physical channel includes several OFDM symbols in the time domain and several subcarriers in the frequency domain. One subframe includes a plurality of OFDM symbols in the time domain. An RB is a resources allocation unit, and includes a plurality of OFDM symbols and a plurality of subcarriers. Furthermore, each subframe may use specific subcarriers of specific OFDM symbols (e.g., the first OFDM symbol) of the corresponding subframe for a physical downlink control channel (PDCCH), that is, an L1/L2 control channel. A Transmission Time Interval (TTI) is a unit time for subframe transmission.

The RRC state of UE and an RRC connection method are described below.

The RRC state means whether or not the RRC layer of UE is logically connected to the RRC layer of the E-UTRAN. A case where the RRC layer of UE is logically connected to the RRC layer of the E-UTRAN is referred to as an RRC connected state. A case where the RRC layer of UE is not logically connected to the RRC layer of the E-UTRAN is referred to as an RRC idle state. The E-UTRAN may check the existence of corresponding UE in the RRC connected state in each cell because the UE has RRC connection, so the UE may be effectively controlled. In contrast, the E-UTRAN is unable to check UE in the RRC idle state, and a Core Network (CN) manages UE in the RRC idle state in each tracking area, that is, the unit of an area greater than a cell. That is, the existence or non-existence of UE in the RRC idle state is checked only for each large area. Accordingly, the UE needs to shift to the RRC connected state in order to be provided with common mobile communication service, such as voice or data.

When a user first powers UE, the UE first searches for a proper cell and remains in the RRC idle state in the corresponding cell. The UE in the RRC idle state establishes RRC connection with an E-UTRAN through an RRC connection procedure when it is necessary to set up the RRC connection, and shifts to the RRC connected state. A case where UE in the RRC idle state needs to set up RRC connection includes several cases. For example, the cases may include a need to send uplink data for a reason, such as a call attempt by a user, and to send a response message as a response to a paging message received from an E-UTRAN.

A Non-Access Stratum (NAS) layer placed over the RRC layer performs functions, such as session management and mobility management.

In the NAS layer, in order to manage the mobility of UE, two types of states: EPS Mobility Management-REGISTERED (EMM-REGISTERED) and EMM-DEREGISTERED are defined. The two states are applied to UE and the MME. UE is initially in the EMM-DEREGISTERED state. In order to access a network, the UE performs a procedure of registering it with the corresponding network through an initial attach procedure. If the attach procedure is successfully performed, the UE and the MME become the EMM-REGISTERED state.

In order to manage signaling connection between UE and the EPC, two types of states: an EPS Connection Management (ECM)-IDLE state and an ECM-CONNECTED state are defined. The two states are applied to UE and the MME. When the UE in the ECM-IDLE state establishes RRC connection with the E-UTRAN, the UE becomes the ECM-CONNECTED state. The MME in the ECM-IDLE state becomes the ECM-CONNECTED state when it establishes S1 connection with the E-UTRAN. When the UE is in the ECM-IDLE state, the E-UTRAN does not have information about the context of the UE. Accordingly, the UE in the ECM-IDLE state performs procedures related to UE-based mobility, such as cell selection or cell reselection, without a need to receive a command from a network. In contrast, when the UE is in the ECM-CONNECTED state, the mobility of the UE is managed in response to a command from a network. If the location of the UE in the ECM-IDLE state is different from a location known to the network, the UE informs the network of its corresponding location through a tracking area update procedure.

System information is described below.

System information includes essential information that needs to be known by UE in order for the UE to access a BS. Accordingly, the UE needs to have received all pieces of system information before accessing the BS, and needs to always have the up-to-date system information. Furthermore, the BS periodically transmits the system information because the system information is information that needs to be known by all UEs within one cell. The system information is divided into a Master Information Block (MIB) and a plurality of System Information Blocks (SIBs).

The MIB may include a limited number of parameters that are most essential and most frequently transmitted when other information is required to be obtained from a cell. UE first searches for an MIB after downlink synchronization. The MIB may include information, such as an SFN that supports downlink channel bandwidth, a PHICH configuration, and synchronization and operates as a timing criterion and an eNB transmit antenna configuration. The MIB may be transmitted on a broadcast channel (BCH) through broadcasting.

SystemInformationBlockType1 (SIB1) of included SIBs is included in a “SystemInformationBlockType1” message and transmitted. The remaining SIBs other than the SIB1 is included in a system information message and transmitted. To map the SIBs to the system information message may be flexibly configured by a scheduling information list parameter included in the SIB1. In this case, each of the SIBs is included in a single system information message, and only SIBs having the same scheduling requirement value (e.g. cycle) may be mapped to the same system information message. Furthermore, a SystemInformationBlockType2 (SIB2) is always mapped to a system information message corresponding to the first entry within the system information message list of a scheduling information list. A plurality of system information messages may be transmitted within the same cycle. The SIB1 and all the system information messages are transmitted on a DL-SCH.

In addition to broadcast transmission, in an E-UTRAN, the SIB1 may be dedicated-signaled in the state in which it includes a parameter configured like an existing configured value. In this case, the SIB1 may be included in an RRC connection reconfiguration message and transmitted.

The SIB1 includes information related to UE cell access, and defines the scheduling of other SIBs. The SIB1 may include information related to the PLMN identifiers of a network, tracking area code (TAC) and a cell ID, a cell barring status indicative of whether a cell is a cell on which camp-on is possible, the lowest reception level required within a cell which is used as cell reselection criterion, and the transmission time and cycle of other SIBs.

The SIB2 may include radio resource configuration information common to all pieces of UE. The SIB2 may include information related to an uplink carrier frequency and uplink channel bandwidth, an RACH configuration, a page configuration, an uplink power control configuration, a sounding reference signal configuration, a PUCCH configuration supporting ACK/NACK transmission, and a PUSCH configuration.

UE may apply a procedure for obtaining system information and detecting a change of system information to a primary cell (PCell) only. In a secondary cell (SCell), when a corresponding SCell is added, an E-UTRAN may provide all of pieces of system information related to an RRC connection state operation through dedicated signaling. When system information related to a configured SCell is changed, an E-UTRAN may release an SCell that is taken into consideration and subsequently add the changed system information. This may be performed along with a single RRC connection reconfiguration message. An E-UTRAN may configure parameter values different from a value broadcasted within an SCell that has been taken into consideration through dedicated signaling.

UE needs to guarantee the validity of a specific type of system information, and such system information is called required system information. The required system information may be defined as follows.
If UE is an RRC idle state: The UE needs to be guaranteed so that it has the valid versions of the MIB and the SIB1 in addition to the SIB2 to SIB8. This may comply with the support of a radio access technology (RAT) that is taken into consideration.
If UE is an RRC connection state: The UE needs to be guaranteed so that it has the valid versions of the MIB, the SIB1, and the SIB2.

In general, the validity of system information may be guaranteed up to a maximum of 3 hours after the system information is obtained.

In general, service that is provided to UE by a network may be classified into three types as follows. Furthermore, the UE differently recognizes the type of cell depending on what service may be provided to the UE. In the following description, a service type is first described, and the type of cell is described.

1) Limited service: this service provides emergency calls and an Earthquake and Tsunami Warning System (ETWS), and may be provided by an acceptable cell.

2) Suitable service: this service means public service for common uses, and may be provided by a suitable cell (or a normal cell).

3) Operator service: this service means service for communication network operators. This cell may be used by only communication network operators, but may not be used by common users.

In relation to a service type provided by a cell, the type of cell may be classified as follows.

1) An acceptable cell: this cell is a cell from which UE may be provided with limited service. This cell is a cell that has not been barred from a viewpoint of corresponding UE and that satisfies the cell selection criterion of the UE.

2) A suitable cell: this cell is a cell from which UE may be provided with suitable service. This cell satisfies the conditions of an acceptable cell and also satisfies additional conditions. The additional conditions include that the suitable cell needs to belong to a Public Land Mobile Network (PLMN) to which corresponding UE may access and that the suitable cell is a cell on which the execution of a tracking area update procedure by the UE is not barred. If a corresponding cell is a CSG cell, the cell needs to be a cell to which UE may access as a member of the CSG

3) A barred cell: this cell is a cell that broadcasts information indicative of a barred cell through system information.

4) A reserved cell: this cell is a cell that broadcasts information indicative of a reserved cell through system information.

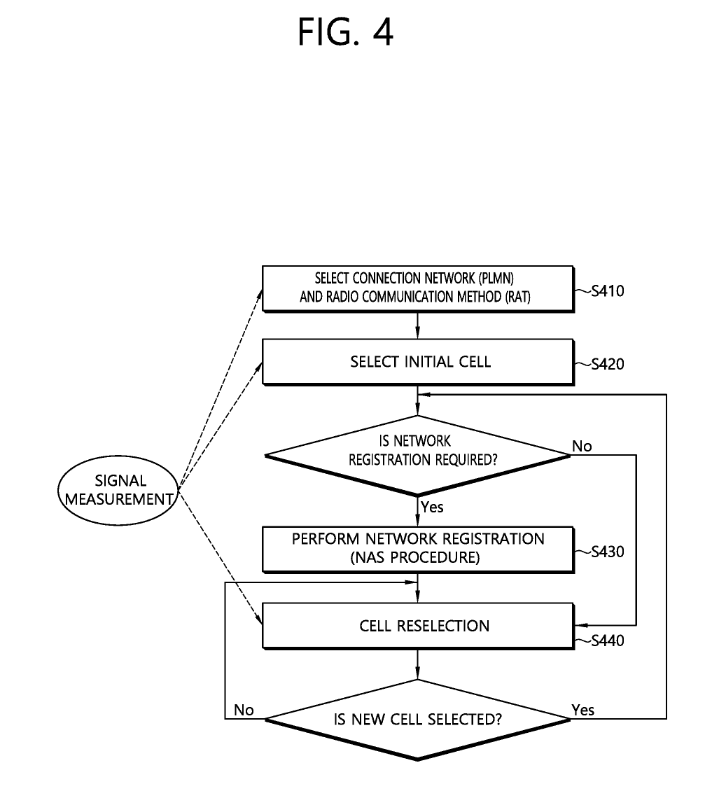

FIG. 4 is a flowchart illustrating the operation of UE in the RRC idle state. FIG. 4 illustrates a procedure in which UE that is initially powered on experiences a cell selection procedure, registers it with a network, and then performs cell reselection if necessary.

Referring to FIG. 4, the UE selects Radio Access Technology (RAT) in which the UE communicates with a Public Land Mobile Network (PLMN), that is, a network from which the UE is provided with service (S410). Information about the PLMN and the RAT may be selected by the user of the UE, and the information stored in a Universal Subscriber Identity Module (USIM) may be used.

The UE selects a cell that has the greatest value and that belongs to cells having measured BS and signal intensity or quality greater than a specific value (cell selection) (S420). In this case, the UE that is powered off performs cell selection, which may be called initial cell selection. A cell selection procedure is described later in detail. After the cell selection, the UE receives system information periodically by the BS. The specific value refers to a value that is defined in a system in order for the quality of a physical signal in data transmission/reception to be guaranteed. Accordingly, the specific value may differ depending on applied RAT.

If network registration is necessary, the UE performs a network registration procedure (S430). The UE registers its information (e.g., an IMSI) with the network in order to receive service (e.g., paging) from the network. The UE does not register it with a network whenever it selects a cell, but registers it with a network when information about the network (e.g., a Tracking Area Identity (TAI)) included in system information is different from information about the network that is known to the UE.

The UE performs cell reselection based on a service environment provided by the cell or the environment of the UE (S440). If the value of the intensity or quality of a signal measured based on a BS from which the UE is provided with service is lower than that measured based on a BS of a neighboring cell, the UE selects a cell that belongs to other cells and that provides better signal characteristics than the cell of the BS that is accessed by the UE. This procedure is called cell reselection differently from the initial cell selection of the No. 2 procedure. In this case, temporal restriction conditions are placed in order for a cell to be frequently reselected in response to a change of signal characteristic. A cell reselection procedure is described later in detail.

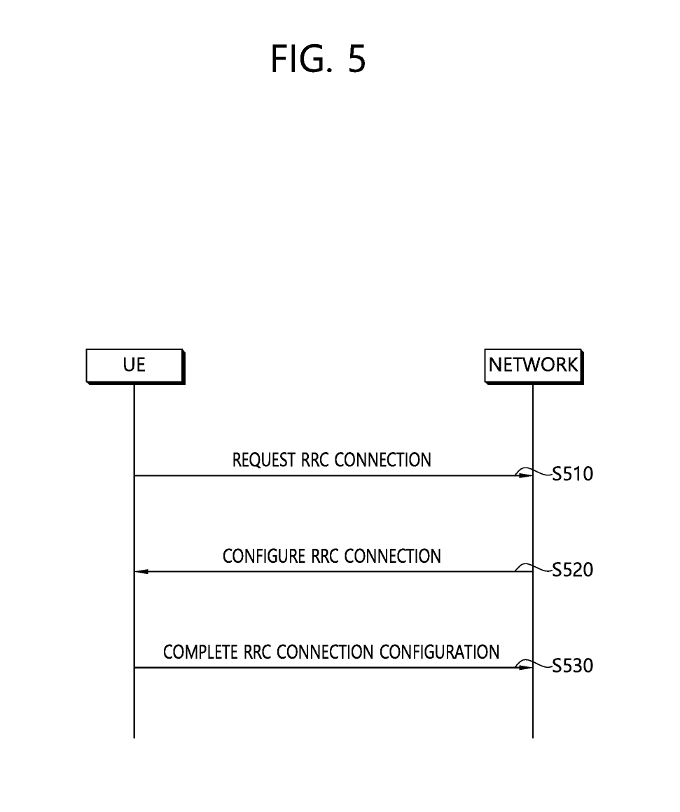

FIG. 5 is a flowchart illustrating a procedure of establishing RRC connection.

UE sends an RRC connection request message that requests RRC connection to a network (S510). The network sends an RRC connection establishment message as a response to the RRC connection request (S520). After receiving the RRC connection establishment message, the UE enters RRC connected mode.

The UE sends an RRC connection establishment complete message used to check the successful completion of the RRC connection to the network (S530).

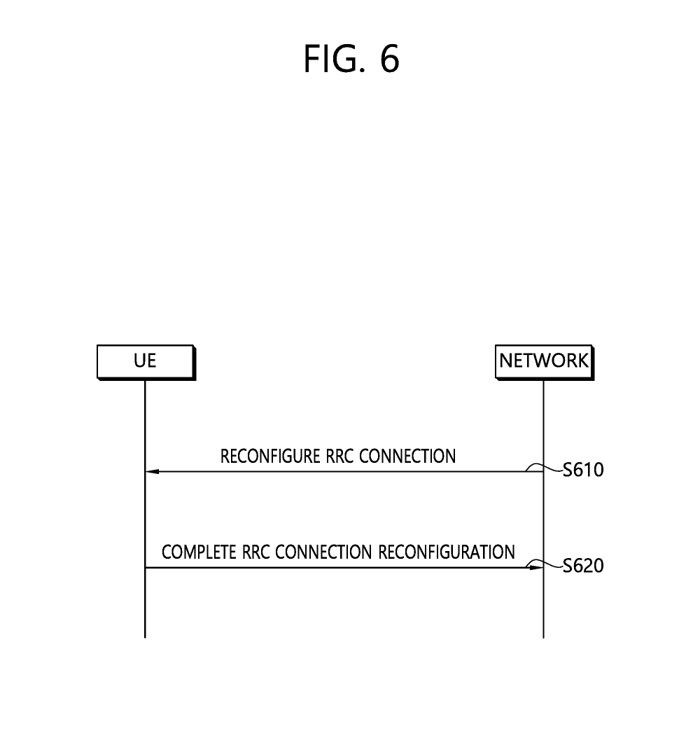

FIG. 6 is a flowchart illustrating an RRC connection reconfiguration procedure. An RRC connection reconfiguration is used to modify RRC connection. This is used to establish/modify/release RBs, perform handover, and set up/modify/release measurements.

A network sends an RRC connection reconfiguration message for modifying RRC connection to UE (S610). As a response to the RRC connection reconfiguration message, the UE sends an RRC connection reconfiguration complete message used to check the successful completion of the RRC connection reconfiguration to the network (S620).

Hereinafter, a public land mobile network (PLMN) is described.

The PLMN is a network which is disposed and operated by a mobile network operator. Each mobile network operator operates one or more PLMNs. Each PLMN may be identified by a Mobile Country Code (MCC) and a Mobile Network Code (MNC). PLMN information of a cell is included in system information and broadcasted.

In PLMN selection, cell selection, and cell reselection, various types of PLMNs may be considered by the terminal.

Home PLMN (HPLMN): PLMN having MCC and MNC matching with MCC and MNC of a terminal IMSI.

Equivalent HPLMN (EHPLMN): PLMN serving as an equivalent of an HPLMN.

Registered PLMN (RPLMN): PLMN successfully finishing location registration.

Equivalent PLMN (EPLMN): PLMN serving as an equivalent of an RPLMN.

Each mobile service consumer subscribes in the HPLMN. When a general service is provided to the terminal through the HPLMN or the EHPLMN, the terminal is not in a roaming state. Meanwhile, when the service is provided to the terminal through a PLMN except for the HPLMN/EHPLMN, the terminal is in the roaming state. In this case, the PLMN refers to a Visited PLMN (VPLMN).

When UE is initially powered on, the UE searches for available Public Land Mobile Networks (PLMNs) and selects a proper PLMN from which the UE is able to be provided with service. The PLMN is a network that is deployed or operated by a mobile network operator. Each mobile network operator operates one or more PLMNs. Each PLMN may be identified by Mobile Country Code (MCC) and Mobile Network Code (MNC). Information about the PLMN of a cell is included in system information and broadcasted. The UE attempts to register it with the selected PLMN. If registration is successful, the selected PLMN becomes a Registered PLMN (RPLMN). The network may signalize a PLMN list to the UE. In this case, PLMNs included in the PLMN list may be considered to be PLMNs, such as RPLMNs. The UE registered with the network needs to be able to be always reachable by the network. If the UE is in the ECM-CONNECTED state (identically the RRC connection state), the network recognizes that the UE is being provided with service. If the UE is in the ECM-IDLE state (identically the RRC idle state), however, the situation of the UE is not valid in an eNB, but is stored in the MME. In such a case, only the MME is informed of the location of the UE in the ECM-IDLE state through the granularity of the list of Tracking Areas (TAs). A single TA is identified by a Tracking Area Identity (TAI) formed of the identifier of a PLMN to which the TA belongs and Tracking Area Code (TAC) that uniquely expresses the TA within the PLMN.

Thereafter, the UE selects a cell that belongs to cells provided by the selected PLMN and that has signal quality and characteristics on which the UE is able to be provided with proper service.

The following is a detailed description of a procedure of selecting a cell by a terminal.

When power is turned-on or the terminal is located in a cell, the terminal performs procedures for receiving a service by selecting/reselecting a suitable quality cell.

A terminal in an RRC idle state should prepare to receive a service through the cell by always selecting a suitable quality cell. For example, a terminal where power is turned-on just before should select the suitable quality cell to be registered in a network. If the terminal in an RRC connection state enters in an RRC idle state, the terminal should selects a cell for stay in the RRC idle state. In this way, a procedure of selecting a cell satisfying a certain condition by the terminal in order to be in a service idle state such as the RRC idle state refers to cell selection. Since the cell selection is performed in a state that a cell in the RRC idle state is not currently determined, it is important to select the cell as rapid as possible. Accordingly, if the cell provides a wireless signal quality of a predetermined level or greater, although the cell does not provide the best wireless signal quality, the cell may be selected during a cell selection procedure of the terminal.

A method and a procedure of selecting a cell by a terminal in a 3GPP LTE is described with reference to 3GPP TS 36.304 V8.5.0 (2009-03) “User Equipment (UE) procedures in idle mode (Release 8)”.

A cell selection procedure is basically divided into two types.

The first is an initial cell selection procedure. In this procedure, UE does not have preliminary information about a wireless channel. Accordingly, the UE searches for all wireless channels in order to find out a proper cell. The UE searches for the strongest cell in each channel Thereafter, if the UE has only to search for a suitable cell that satisfies a cell selection criterion, the UE selects the corresponding cell.

Next, the UE may select the cell using stored information or using information broadcasted by the cell. Accordingly, cell selection may be fast compared to an initial cell selection procedure. If the UE has only to search for a cell that satisfies the cell selection criterion, the UE selects the corresponding cell. If a suitable cell that satisfies the cell selection criterion is not retrieved though such a procedure, the UE performs an initial cell selection procedure.

A cell selection criterion may be defined as in Equation 1 below. Following Equation 1 can be referred to as measurement for determining whether or not S-criterion is satisfied.

Srxlev>0 AND Squal>0. [Equation 1]
where:
Srxlev=Qᵣₓₗₑᵥₘₑₐₛ−(Qᵣₓₗₑᵥₘᵢₙ+Q_{rxlevminoffset})−P_{compensation},
Squal=Q_{qualmeas}−(Q_{qualmin}+Q_{qualminoffset})

TABLE 1

| | |
|---|---|
| Srxlev | Cell selection RX level value (dB) |
| Squal | Cell selection quality value (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm) |
| Q_{qualmin} | Minimum required quality level in the cell (dB) |
| Q_{rxlevminoffset} | Offset to the signalled Qᵣₓₗₑᵥₘᵢₙ taken into account in the |
| | Srxlev evaluation as a result of a periodic search for a |
| | higher priority PLMN while camped normally in a |
| | VPLMN |
| Q_{qualminoffset} | Offset to the signalled Q_{qualmin} taken into account in the |
| | Squal evaluation as a result of a periodic search for a |
| | higher priority PLMN while camped normally in a |
| | VPLMN |
| Pcompensation | max(P_{EMAX} − P_{PowerClass}, 0) (dB) |
| P_{EMAX} | Maximum TX power level an UE may use when |
| | transmitting on the uplink in the cell (dBm) defined as |
| | P_{EMAX} in [TS 36.101] |
| P_{PowerClass} | Maximum RF output power of the UE (dBm) according |
| | to the UE power class as defined in [TS 36.101] |

Qrxlevminoffset and Qqualminoffset, that is, signaled values, are the results of periodic discovery for a PLMN having higher priority while UE camps on a normal cell within a VPLMN, and may be applied only when cell selection is evaluated. As described above, during the periodic discovery of a PLMN having higher priority, UE may perform cell selection evaluation using parameter values stored from another cell of the PLMN having such higher priority.

After UE selects any cell through a cell selection procedure, the intensity or quality of a signal between the UE and a BS may be changed due to the mobility of the UE or a change of a radio environment. Accordingly, if the quality of the selected cell is changed, the UE may select another cell providing better quality.

After the UE selects a specific cell through the cell selection procedure, the intensity or quality of a signal between the UE and a BS may be changed due to a change in the mobility or wireless environment of the UE. Accordingly, if the quality of the selected cell is deteriorated, the UE may select another cell that provides better quality. If a cell is reselected as described above, the UE selects a cell that provides better signal quality than the currently selected cell. Such a procedure is called cell reselection. In general, a basic object of the cell reselection procedure is to select a cell that provides UE with the best quality from a viewpoint of the quality of a radio signal.

In addition to the viewpoint of the quality of a radio signal, a network may determine priority corresponding to each frequency, and may inform the UE of the determined priorities. The UE that has received the priorities preferentially takes into consideration the priorities in a cell reselection procedure compared to a radio signal quality criterion.

As described above, there is a method of selecting or reselecting a cell according to the signal characteristics of a wireless environment. In selecting a cell for reselection when a cell is reselected, the following cell reselection methods may be present according to the RAT and frequency characteristics of the cell.
Intra-frequency cell reselection: UE reselects a cell having the same center frequency as that of RAT, such as a cell on which the UE camps on.
Inter-frequency cell reselection: UE reselects a cell having a different center frequency from that of RAT, such as a cell on which the UE camps on
Inter-RAT cell reselection: UE reselects a cell that uses RAT different from RAT on which the UE camps

The principle of a cell reselection procedure is as follows.

First, UE measures the quality of a serving cell and neighbor cells for cell reselection.

Second, cell reselection is performed based on a cell reselection criterion. The cell reselection criterion has the following characteristics in relation to the measurements of a serving cell and neighbor cells.

Intra-frequency cell reselection is basically based on ranking. Ranking is a task for defining a criterion value for evaluating cell reselection and numbering cells using criterion values according to the size of the criterion values. A cell having the best criterion is commonly called the best-ranked cell. The cell criterion value is based on the value of a corresponding cell measured by UE, and may be a value to which a frequency offset or cell offset has been applied, if necessary.

Inter-frequency cell reselection is based on frequency priority provided by a network. UE attempts to camp on a frequency having the highest frequency priority. A network may provide frequency priority that will be applied by UEs within a cell in common through broadcasting signaling, or may provide frequency-specific priority to each UE through UE-dedicated signaling. A cell reselection priority provided through broadcast signaling may refer to a common priority. A cell reselection priority for each terminal set by a network may refer to a dedicated priority. If receiving the dedicated priority, the terminal may receive a valid time associated with the dedicated priority together. If receiving the dedicated priority, the terminal starts a validity timer set as the received valid time together therewith. While the valid timer is operated, the terminal applies the dedicated priority in the RRC idle mode. If the valid timer is expired, the terminal discards the dedicated priority and again applies the common priority.

For the inter-frequency cell reselection, a network may provide UE with a parameter (e.g., a frequency-specific offset) used in cell reselection for each frequency. For the intra-frequency cell reselection or the inter-frequency cell reselection, a network may provide UE with a Neighboring Cell List (NCL) used in cell reselection. The NCL includes a cell-specific parameter (e.g., a cell-specific offset) used in cell reselection. For the intra-frequency or inter-frequency cell reselection, a network may provide UE with a cell reselection black list used in cell reselection.

The UE does not perform cell reselection on a cell included in the black list.

Ranking performed in a cell reselection evaluation procedure is described below.

A ranking criterion used to give the priority of a cell is defined as in Equation 2.

Rₛ=Q_{meas,s}+Q_{hyst},Rₙ=Q_{meas,n}−Q_{offset} [Equation 2]

In Equation 2, Rs is the ranking criterion of a serving cell on which UE now camps, Rn is the ranking criterion of a neighboring cell, Qmeas,s is the quality value of the serving cell measured by the UE, Qmeas,n is the quality value of the neighboring cell measured by the UE, Qhyst is a hysteresis value for ranking, and Qoffset is an offset between the two cells.

In Intra-frequency, if UE receives an offset “Qoffsets,n” between a serving cell and a neighbor cell, Qoffset=Qoffsets,n. If UE does not Qoffsets,n, Qoffset=0.

In Inter-frequency, if UE receives an offset “Qoffsets,n” for a corresponding cell, Qoffset=Qoffsets,n+Qfrequency. If UE does not receive “Qoffsets,n”, Qoffset=Qfrequency.

If the ranking criterion Rs of a serving cell and the ranking criterion Rn of a neighbor cell are changed in a similar state, ranking priority is frequency changed as a result of the change, and UE may alternately reselect the twos. Qhyst is a parameter that gives hysteresis to cell reselection so that UE is prevented from to alternately reselecting two cells.

UE measures RS of a serving cell and Rn of a neighbor cell according to the above equation, considers a cell having the greatest ranking criterion value to be the best-ranked cell, and reselects the cell.

In accordance with the criterion, it may be checked that the quality of a cell is the most important criterion in cell reselection. If a reselected cell is not a suitable cell, UE excludes a corresponding frequency or a corresponding cell from the subject of cell res election.

Hereinafter, radio link failure (RLF) will be described.

UE continues to perform measurements in order to maintain the quality of a radio link with a serving cell from which the UE receives service. The UE determines whether or not communication is impossible in a current situation due to the deterioration of the quality of the radio link with the serving cell. If communication is almost impossible because the quality of the serving cell is too low, the UE determines the current situation to be an RLF.

If the RLF is determined, the UE abandons maintaining communication with the current serving cell, selects a new cell through cell selection (or cell reselection) procedure, and attempts RRC connection re-establishment with the new cell.

In the specification of 3GPP LTE, the following examples are taken as cases where normal communication is impossible.
A case where UE determines that there is a serious problem in the quality of a downlink communication link (a case where the quality of a PCell is determined to be low while performing RLM) based on the radio quality measured results of the PHY layer of the UE
A case where uplink transmission is problematic because a random access procedure continues to fail in the MAC sublayer.
A case where uplink transmission is problematic because uplink data transmission continues to fail in the RLC sublayer.
A case where handover is determined to have failed.
A case where a message received by UE does not pass through an integrity check.

An RRC connection re-establishment procedure is described in more detail below.

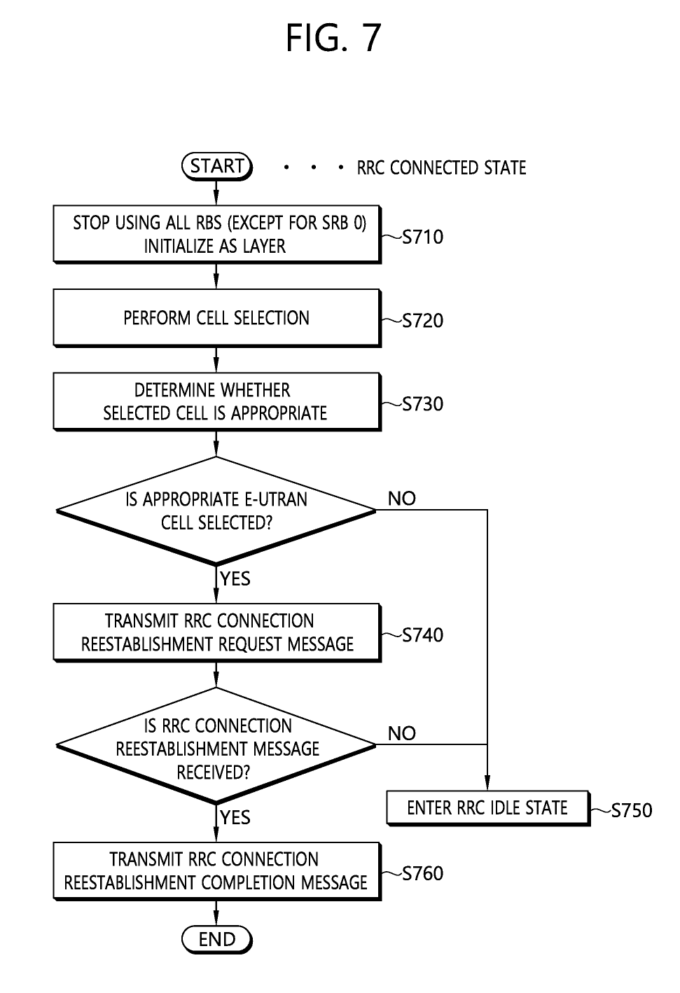

FIG. 7 is a diagram illustrating an RRC connection re-establishment procedure.

Referring to FIG. 7, UE stops using all the radio bearers that have been configured other than a Signaling Radio Bearer (SRB) #0, and initializes a variety of kinds of sublayers of an Access Stratum (AS) (S710). Furthermore, the UE configures each sublayer and the PHY layer as a default configuration. In this procedure, the UE maintains the RRC connection state.

The UE performs a cell selection procedure for performing an RRC connection reconfiguration procedure (S720). The cell selection procedure of the RRC connection re-establishment procedure may be performed in the same manner as the cell selection procedure that is performed by the UE in the RRC idle state, although the UE maintains the RRC connection state.

After performing the cell selection procedure, the UE determines whether or not a corresponding cell is a suitable cell by checking the system information of the corresponding cell (S730). If the selected cell is determined to be a suitable E-UTRAN cell, the UE sends an RRC connection re-establishment request message to the corresponding cell (S740).

Meanwhile, if the selected cell is determined to be a cell that uses RAT different from that of the E-UTRAN through the cell selection procedure for performing the RRC connection re-establishment procedure, the UE stops the RRC connection re-establishment procedure and enters the RRC idle state (S750).

The UE may be implemented to finish checking whether the selected cell is a suitable cell through the cell selection procedure and the reception of the system information of the selected cell. To this end, the UE may drive a timer when the RRC connection re-establishment procedure is started. The timer may be stopped if it is determined that the UE has selected a suitable cell. If the timer expires, the UE may consider that the RRC connection re-establishment procedure has failed, and may enter the RRC idle state. Such a timer is hereinafter called an RLF timer. In LTE spec TS 36.331, a timer named “T311” may be used as an RLF timer. The UE may obtain the set value of the timer from the system information of the serving cell.

If an RRC connection re-establishment request message is received from the UE and the request is accepted, a cell sends an RRC connection re-establishment message to the UE.

The UE that has received the RRC connection re-establishment message from the cell reconfigures a PDCP sublayer and an RLC sublayer with an SRB1. Furthermore, the UE calculates various key values related to security setting, and reconfigures a PDCP sublayer responsible for security as the newly calculated security key values. Accordingly, the SRB1 between the UE and the cell is open, and the UE and the cell may exchange RRC control messages. The UE completes the restart of the SRB1, and sends an RRC connection re-establishment complete message indicative of that the RRC connection re-establishment procedure has been completed to the cell (S760).

In contrast, if the RRC connection re-establishment request message is received from the UE and the request is not accepted, the cell sends an RRC connection re-establishment reject message to the UE.

If the RRC connection re-establishment procedure is successfully performed, the cell and the UE perform an RRC connection reconfiguration procedure. Accordingly, the UE recovers the state prior to the execution of the RRC connection re-establishment procedure, and the continuity of service is guaranteed to the upmost.

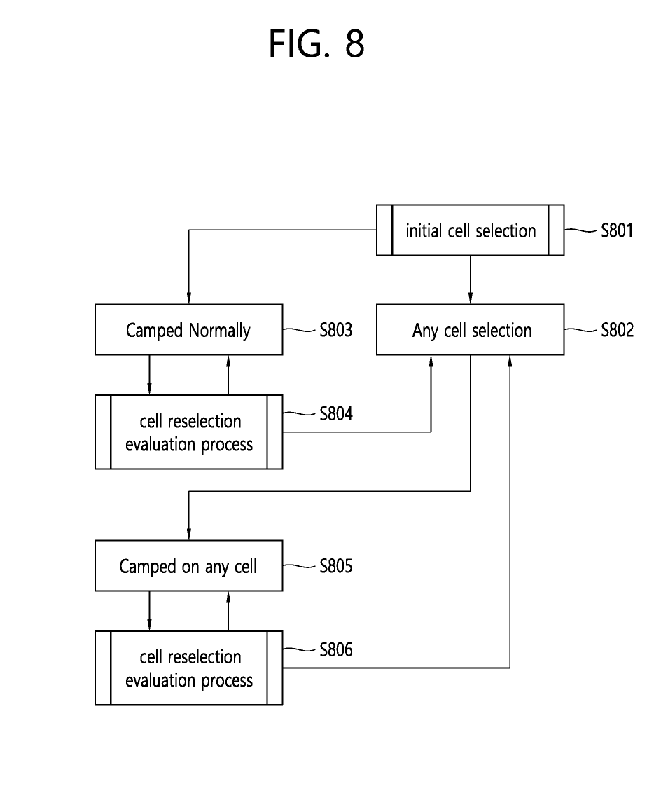

FIG. 8 illustrates sub states where the terminal may have in an RRC_IDLE state and a sub state transition process.

Referring to FIG. 8, a terminal performs an initial cell selection process (S801). The initial cell selection process may be performed when there is no stored cell information with respect to the PLMN or a suitable cell is not found.

If the suitable cell is not found in the initial cell selection process, the terminal transitions to an any cell selection state (S802). The optional cell selection state represents a state which does not camp on in both of a suitable cell and an acceptable cell. The optional cell selection state is a state attempted by the terminal in order to find an acceptable cell of an optional PLMN which may camp on. When the terminal finds no cells which may camp on, the terminal is continuously maintained in an optional cell selection state until the acceptable cell is found.

If the suitable cell is found in the initial cell selection process, the state transits to a normal camp state (S803). The normal camp state represents a state which camps on the normal cell. A paging channel is selected according to information given through system information to motor, and an evaluation process for cell reselection may be performed.

In the normal camp state (S803), if a cell reselection evaluation process (S804) is caused, the cell reselection evaluation process (S804) is performed. If a suitable cell is found in the cell reselection evaluation process (S804), the terminal again transits to the normal camp state (S803).

If an acceptable cell is found in the any cell selection state (S802), the terminal transits to an any cell camped state (S805). The any cell camped state (S805) represents a state of camping on an acceptable cell.

In the any cell camped state (S805), the terminal may select a paging channel according to information given through system information to monitor, and may perform a cell reselection evaluation process (S806). If the acceptable cell is not found in the cell reselection evaluation process (S806), the terminal transits the any cell selection state (S802).

Hereinafter, a D2D operation will be described. In the 3GPP LTE-A, a service related to the D2D operation refers to Proximity based Services (ProSe). Hereinafter, the ProSe is an equivalent concept with the D2D operation and the ProSe may be compatibly used with the D2D operation. The ProSe is now described.

The ProSe includes ProSe direct communication and ProSe direct discovery. The ProSe direct communication presents communication performed by two or more adjacent terminals. The terminals may perform communication using a protocol of a user plane. A ProSe-enabled UE means a UE for supporting a process related to requirements of the ProSe. Unless otherwise defined, the ProSe-enabled UE includes both of a public safety UE and a non-public safety UE. The public safety UE represents a UE for supporting both of a public safety specified function and the ProSe process. The non-public safety UE is a terminal which supports the ProSe process but does not support the public safety specified function.

The ProSe direct discovery is a process where the ProSe-enabled UE discovers another ProSe-enabled UE. In this case, only ability of the two ProSe-enabled UEs is used. An EPC-level ProSe discovery signifies a process where an EPC determines whether 2 ProSe enable terminals are closed to each other, and reports the close state thereof the two ProSe enabled terminals.

Hereinafter, the ProSe direct communication may refer to D2D communication, and the ProSe direct discovery may refer to D2D discovery.

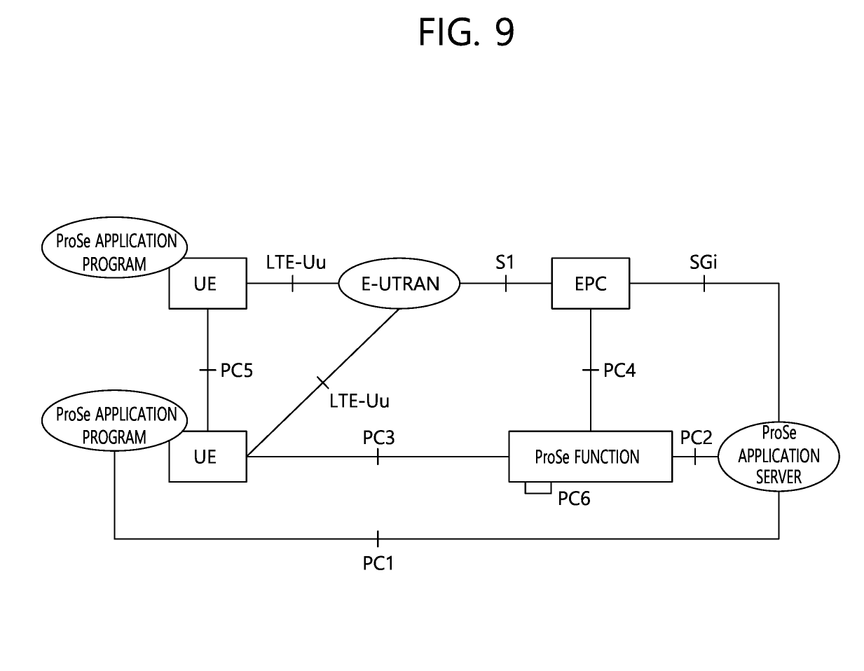

FIG. 9 illustrates a reference structure for a ProSe.

Referring to FIG. 9, the reference structure for a ProSe includes a plurality of terminals having E-UTRAN, EPC, and ProSe application program, a ProSe application (APP) server, and a ProSe function.

An EPC is a representative example of the E-UTRAN. The EPC may include an MME, an S-GW, a P-GW, a policy and charging rules function (PCRF), and a home subscriber server (HSS).

The ProSe application server is a user of ProSe in order to make an application function. The ProSe application server may communicate with an application program in the terminal. The application program in the terminal may use a ProSe ability to make an application function.

The ProSe function may include at least one of following functions but is not limited thereto.
Interworking via a reference point towards the 3rd party applications
Authorization and configuration of the UE for discovery and direct communication)
Enable the function of the EPC level ProSe discovery
ProSe related new subscriber data and handling of data storage, and also handling of ProSe identities
Security related function
Provide control towards the EPC for policy related function
Provide function for charging (via or outside of EPC, e.g., offline charging))

Hereinafter, a reference point and a reference interface will be described in a reference structure for the ProSe.
PC1: a reference point between a ProSe application program in the terminal and a ProSe application program in a ProSe application server. The PC1 is used to define signaling requirements in an application level.
PC2: is a reference point between the ProSe application server and a ProSe function. The PC2 is used to define an interaction between the ProSe application server and a ProSe function. An application data update of a ProSe database of the ProSe function may be an example of the interaction.
PC3: is a reference point between the terminal and the ProSe function. The PC3 is used to define an interaction between the terminal and the ProSe function. Configuration for ProSe discovery and communication may be an example of the interaction.
PC4: is a reference point between an EPC and the ProSe function. The PC4 is used to define an interaction between the EPC and the ProSe function. The interaction lay illustrate when a path for 1:1 communication or a ProSe service for real time session management or mobility management are authorized.
PC5: is a reference point to use control/user plane for discovery, communication, and relay between terminals, and 1:1 communication.
PC6: is a reference point to use a function such as ProSe discovery between users included in different PLMNs.
SGi: may be used for application data and application level control information exchange.

<ProSe Direct Communication (D2D Communication)>.

The ProSe direct communication is a communication mode where two public safety terminals may perform direct communication through a PC 5 interface. The communication mode may be supported in both of a case of receiving a service in coverage of E-UTRAN or a case of separating the coverage of E-UTRAN.

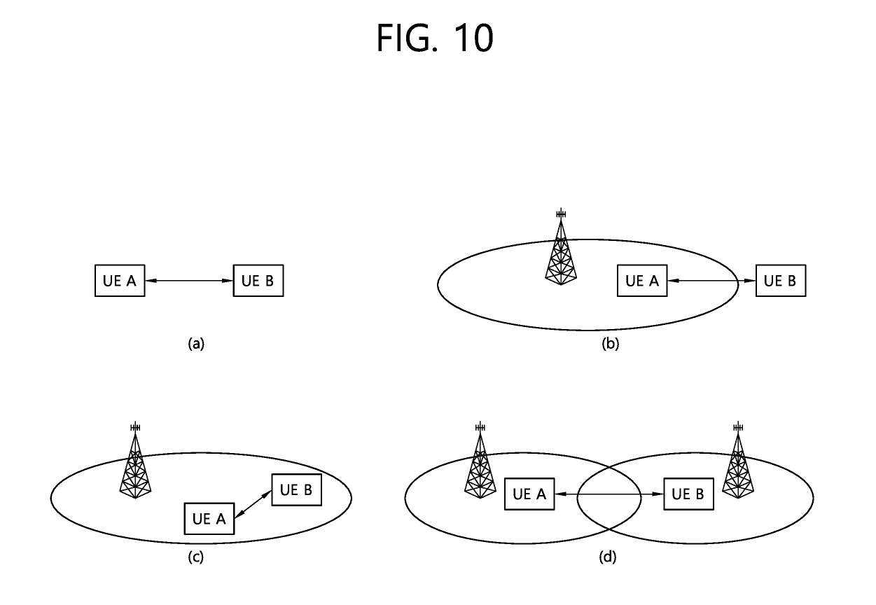

FIG. 10 illustrates arrangement examples of terminals performing ProSe direct communication and cell coverage.

Referring to FIG. 10(a), UEs A and B may be located outside of the cell coverage. Referring to FIG. 10(b), the UE A may be located in the cell coverage and the UE B may be located outside of the cell coverage. Referring to FIG. 10(c), both of UEs A and B may be located in the cell coverage. Referring to FIG. 10(d), the UE A may be located in coverage of a first cell and the UE B may be in coverage of a second cell.

As described above, the ProSe direct communication may be performed between terminals which are provided at various positions.

Meanwhile, following IDs may be used in the ProSe direct communication.

Source layer-2 ID: The source layer-2 ID identifies a sender of a packet in a PC 5 interface.

Purpose layer-2 ID: The purpose layer-2 ID identifies a target of a packet in a PC 5 interface.

SA L1 ID: The SA L1 ID represents an in an ID in a scheduling assignment (SA) in the PC 5 interface.

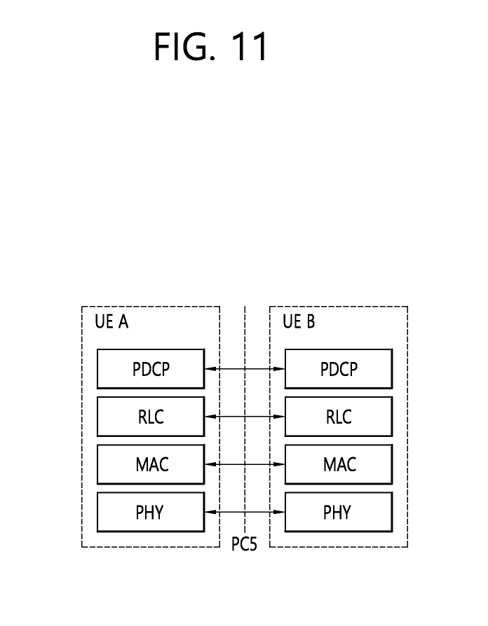

FIG. 11 illustrates a user plane protocol stack for the ProSe direct communication.

Referring to FIG. 11, the PC 5 interface includes a PDCH layer, a RLC layer, a MAC layer, and a PHY layer.

There may not be HARQ feedback in the ProSe direct communication. An MAC header may include the source layer-2 ID and the purpose layer-2 ID.

<Radio Resource Assignment for ProSe Direct Communication>.

A ProSe enable terminal may use following two modes with respect to resource assignments for the ProSe direct communication.

1. Mode 1

The mode 2 is a mode for receiving scheduling a resource for the ProSe direct communication from a base station. The terminal should be in a RRC_CONNECTED state according to the mode 1 in order to transmit data. The terminal requests a transmission resource to the base station, and the base station schedules a resource for scheduling assignment and data transmission. The terminal may transmit a scheduling request to the base station and may transmit a Buffer Status Report (ProSe BSR). The base station has data which the terminal will perform the ProSe direct communication and determines whether a resource for transmitting the data is required.

2. Mode 2

The mode 2 is a mode for selecting a direct resource. The terminal directly selects a resource for the ProSe direct communication from a resource pool. The resource pool may be configured by a network or may be previously determined.

Meanwhile, when the terminal includes a serving cell, that is, when the terminal is in an RRC_CONNECTED state with the base station or is located in a specific cell in an RRC_IDLE state, the terminal is regarded to be in coverage of the base station.

If the terminal is located outside of the coverage, only the mode 2 is applicable. If the terminal is located in the coverage, the mode 1 or the mode 2 may be used according to setting of the base station.

If there are no exceptional conditions, only when the base station is configured, the terminal may change a mode from the mode 1 to the mode 2 or from the mode 2 to the mode 1.

<ProSe Direct Discovery (D2D Discovery)>

The ProSe direct discovery represents a process used to discover when the ProSe enabled terminal discovers other neighboring ProSe enabled terminal and refers to D2D direction discovery or D2D discovery. In this case, an E-UTRA wireless signal through the PC 4 interface may be used. Hereinafter, information used for the ProSe direct discovery refers to discovery information.

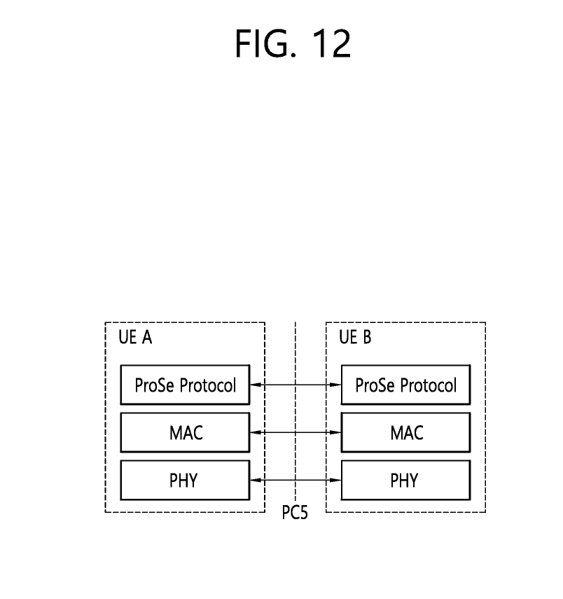

FIG. 12 illustrates a PC 5 interface for D2D discovery.

Referring to FIG. 12, the PC 5 interface includes an MAC layer, a PHY layer, and a ProSe Protocol layer being an upper layer. Permission for announcement and monitoring of discovery information is handled in the upper layer ProSe Protocol. Contents of discovery information are transparent to an access stratum (AS). The ProSe Protocol allows only valid discovery information to be transferred to the AS for announcement.

An MAC layer receives discovery information from the upper layer ProSe Protocol. An IP layer is not used for transmitting the discovery information. The MAC layer determines a resource used in order to announce the discovery information received from the upper layer. The MAC layer makes and sends a protocol data unit (MAC PDU) to a physical layer. An MAC header is not added.

There are two types of resource assignments for announcing the discovery information.

1. Type 1

The type 1 is a method assigned so that resources for announcing the discovery information are not terminal-specific and the base station provides resource pool configuration for announcing the discovery information to the terminals. The configuration may be included in a system information block (SIB) to be signaled in a broadcast scheme. Alternatively, the configuration may be included in a terminal specific RRC message to be provided. Alternatively, the configuration may be broadcast-signaled or terminal-specific signaled of a different layer from the RRC message.

The terminal selects a resource from an indicated resource pool to announce discovery information using the selected resource. The terminal may announce discovery information through a resource optionally selected during each discovery period.

2. Type 2

The type 2 is a method where resources for announcing the discovery information are terminal-specifically assigned. A terminal in a RRC_CONNECTED state may request a resource for announcing a discovery signal to the base station through a RRC signal. The base station may assign a resource for announcing a discovery signal as an RRC signal. A resource for monitoring the discovery signal in a configured resource pool may be assigned in terminals.

With respect to a terminal in an RRC_IDLE state, a base station may report a type 1 resource pool for announcing the discovery signal as an SIB. Terminals where ProSe direct discovery is allowed use a type 1 resource pool for announcing the discovery information in the RRC_IDLE state. Alternatively, the base station 2) reports that the base station supports the ProSe direct discovery through the SIB but may not provide the resource for announcing the discovery information. In this case, the terminal should enter the RRC_CONNECTED state for announcing the discovery information.

With respect to a terminal in an RRC_CONNECTED state, the base station may configure whether to use a type 1 resource pool or a type 2 resource pool for announcing the discovery information through a RRC signal.

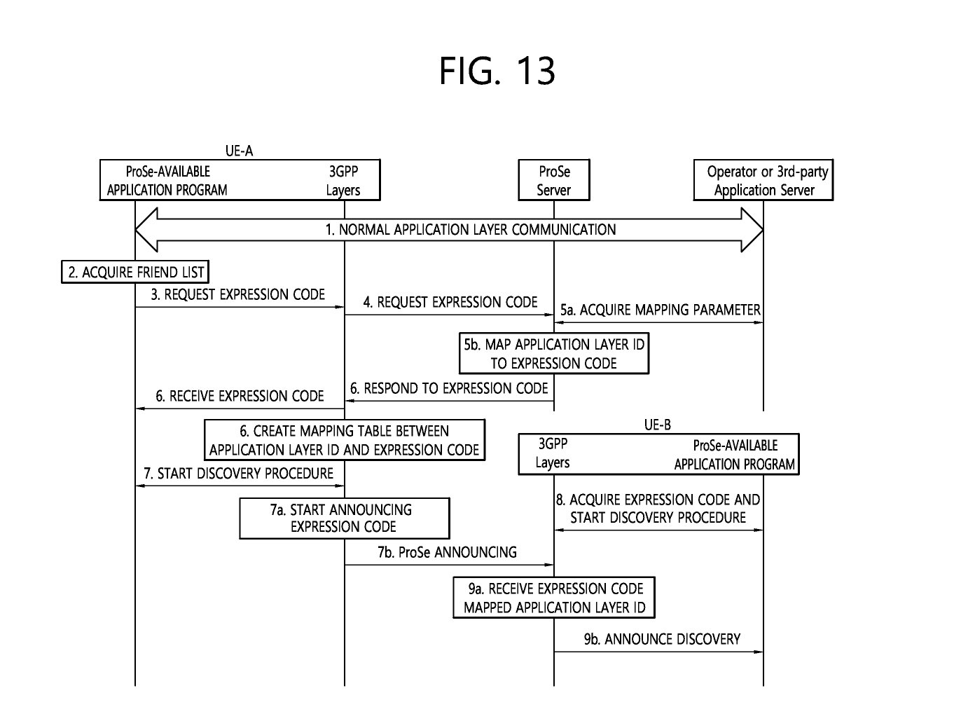

FIG. 13 illustrates an embodiment of a ProSe direct discovery process.

Referring to FIG. 13, it is assumed that a Prose enabled application program is operated in UE A and UE B and the UEs A and B are configured to have a ‘friend’ relationship with each other, that is, a relationship in which D2D communication may be permitted between the UEs A and B in the application program. Hereinafter, the UE B can be expressed as a ‘friend’ of the UE A. The application program may be, for example, a social networking program. ‘3GPP Layers’ corresponds to functions of an application program for using the ProSe discovery service, which is defined by 3GPP.

ProSe direct discovery between the UEs A and B may go through the following process.

1. First, the UE A performs regular application-layer communication with an application server. The communication is based on an application programming interface (API).

2. The ProSe-enabled application program of the UE A receives a list of application layer IDs having the relationship of ‘friend’. The application layer ID may be generally in the form of a network connection ID. For example, the application layer ID of the UE A may be a form such as “adam@example.com”.

3. The UE A requests private expressions codes for a user of the UE A and a personal expression code for the friend of the user.

4. The 3GPP layers transmit an expression code request to a ProSe server.

5. The ProSe server maps the application layer IDs provided by an operator or a third party application server to the personal expressions codes. For example, the application layer ID such as “adam@example.com” may be mapped to the personal expressions code such as “GTER543 #2FSJ67DFSF”. The mapping may be performed based on parameters (e.g., a mapping algorithm, a key value, and the like) received from the application server of a network.

6. The ProSe server responds the derived expressions codes to the 3GPP layers. The 3GPP layers notify to the ProSe enabled application program that the expression codes for the requested application layer ID are successfully received. In addition, a mapping table between the application layer ID and the expression codes is created.

7. The ProSe enabled application program requests starting a discovery procedure to the 3GPP layers. That is, when one of the provided ‘friends’ is near the UE A and direct communication is possible, the ProSe enabled application program attempts the discovery. The 3GPP layers announces the personal expression code (that is, “GTER543 #2FSJ67DFSF” which is the personal expression code of “adam@example.com” in the example) of the UE A. Hereinafter, this will be referred to as ‘announce’. Only ‘friends’ who receive the mapping relationship in advance the mapping between the application layer ID of the corresponding application program and the personal expression code and perform the mapping between the application layer ID of the corresponding application program and the personal expression code.

8. It is assumed that the UE B is operating the same ProSe enabled application program as the UE A and executes steps 3 to 6 described above. The 3GPP layers in the UE B may execute ProSe discovery.

9. When the UE B receives the aforementioned ‘announce’ from the UE A, the UE B determines whether the personal expression code included in the announce is the personal expression code which the UE B knows and whether the personal expression code is mapped with the application layer ID. As described in step 8, since the UE B also executes steps 3 to 6, the UE B knows the personal expression code for the UE A, the mapping of the personal expression code and the application layer ID, and what the corresponding application program is. Accordingly, the UE B may discover the UE A from the announce of the UE A. The 3GPP layers announce that “adam@example.com” is discovered to the ProSe enabled application program in the UE B.

In FIG. 13, the discovery procedure is described by considering all of the UEs A and B, the ProSe server, the application server, and the like. Only in terms of the operation between the UEs A and B, the UE A transmits a signal called announce (this process may be referred to as announcement) and the UE B receives the announce to discover the UE A. That is, by considering that an operation directly related with another UE among the operations performed by respective UEs is only one step, a discovery process of FIG. 13 may be referred to as a single step discovery procedure.

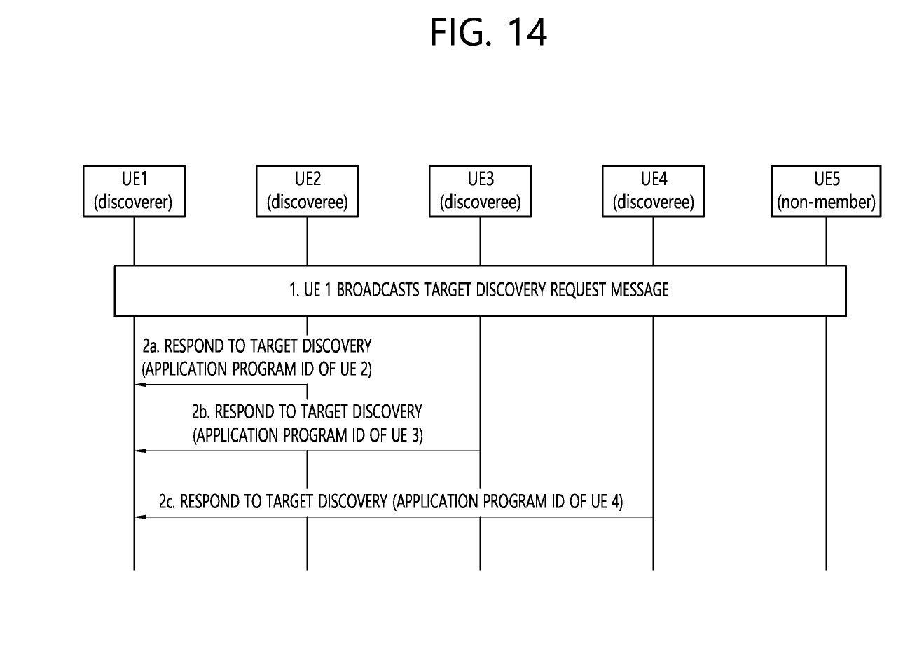

FIG. 14 illustrates another embodiment of the ProSe direct discovery process.

In FIG. 14, it is assumed that UEs 1 to 4 are UEs included in a specific group communication system enablers (GCSE) group. It is assumed that UE 1 is a discoverer and UEs 2, 3, and 4 are discoverees. Terminal 5 is a UE which is irrespective to the discovery process.

Terminal 1 and UEs 2 to 4 may perform the following operations in the discovery process.

First, UE 1 broadcasts a targeted discovery request message (hereinafter, may be abbreviated as discovery request message or M1) in order to discover whether a predetermined UE included in the GCSE group is in the vicinity of UE 1. The targeted discovery request message may include a unique application program group ID or layer-2 group ID of the specific GCSE group. Further, the targeted discovery request message may include a unique ID, that is, an application program personal ID of UE 1. The targeted discovery request message may be received by UEs 2, 3, 4, and 5.

Terminal transmits no response message. On the contrary, UEs 2, 3, and 4 included in the GCSE group transmits a targeted discovery response message (hereinafter, may be abbreviated as discovery response message or M2) as a response to the targeted discovery request message. The targeted discovery response message may include the unique application program personal ID of a UE which transmits the message.

When the operations of the UEs are described during the ProSe discovery process described in FIG. 14, the discoverer (UE 1) transmits the targeted discovery request message and receives the targeted discovery response message as the response thereto. Further, when the discoveree (e.g., UE 2) also receives the targeted discovery request message, the discoveree transmits the targeted discovery response message as the response thereto. Therefore, each UE performs operations of 2 steps. In this aspect, the ProSe discovery process of FIG. 14 may be referred to as a 2-step discovery procedure.

In addition to the discovery procedure described in FIG. 14, when UE 1 (discoverer) transmits a discovery confirm message (hereinafter, may be abbreviated as M3) as the response to the targeted discovery response message, this may be referred to as a 3-step discovery procedure.

Now, the present invention will be described.

Hereinafter, the sidelink means a D2D interface for ProSe communication (sidelink communication, D2D communication, or may be simply referred to as communication) and ProSe discovery (sidelink discovery, D2D discovery, or may be simply referred to as discovery).

In the related art, transmission of a discovery signal is continuously performed only in a serving cell of the UE during a ProSe operation and performed based on a configuration of the serving cell. The UE may not announce in which frequency the UE is interested to the network in order to transmit the discovery signal (this is also expressed as announcing the discovery signal). In a signaling aspect, sidelink UE information used for the UE to announce sidelink information to a base station does not include a field indicating the frequency in which the UE is interested in transmitting the discovery signal.

The following table illustrates one example of sidelink UE information in the related art.

TABLE 2
-- ASN1START

| | |
|---|---|
| SidelinkUEInformation-r12 ::= | SEQUENCE { |
| criticalExtensions | CHOICE { |
| c1 | CHOICE { |
| sidelinkUEInformation-r12 | SidelinkUEInformation-r12- |

```
IEs,
    spare3 NULL, spare2 NULL, spare1 NULL
    },
```

| | |
|---|---|
| criticalExtensionsFuture | SEQUENCE { } |

}
}

| SidelinkUEInformation-r12-IEs ::= | SEQUENCE { |
|---|---|
| commRxInterestedFreq-r12 | ARFCN-ValueEUTRA-r9 |
| OPTIONAL, | |
| commTxResourceReq-r12 | SL-CommTxResourceReq- |
| r12 OPTIONAL, | |
| discRxInterest-r12 | ENUMERATED {true} |
| OPTIONAL, | |
| discTxResourceReq-r12 | INTEGER (1..63) |
| OPTIONAL, | |

| | |
|---|---|
| lateNonCriticalExtension | OCTET STRING |
| OPTIONAL, | |
| nonCriticalExtension | SEQUENCE { } |
| OPTIONAL | |
| } | |
| SL-CommTxResourceReq-r12 ::= | SEQUENCE { |
| carrierFreq-r12 | ARFCN-ValueEUTRA-r9 |
| OPTIONAL, | |
| destinationInfoList-r12 | SL-DestinationInfoList-r12 |
| } | |

SL-DestinationInfoList-r12 ::= SEQUENCE (SIZE (1..maxSL-Dest-r12))
OF SL-DestinationIdentity-r12
SL-DestinationIdentity-r12 ::= BIT STRING (SIZE (24))
-- ASN1STOP

In the table, ‘commRxInterestedFreq’ indicates a frequency in which the UE is interested in receiving the sidelink communication. ‘commTxResourceReq’ indicates a frequency in which the UE is interested in transmitting the sidelink communication. ‘commTxResourceReq’ represents that the UE is interested in monitoring the sidelink discovery.

As shown in Table 2, in the related art, a field indicating the ‘frequency in which the UE is interested in transmitting the discovery signal’ to the network does not exist in the sidelink UE information. Further, the sidelink UE information in the related art does not also include information indicating which cell the UE uses in order to transmit the discovery signal.

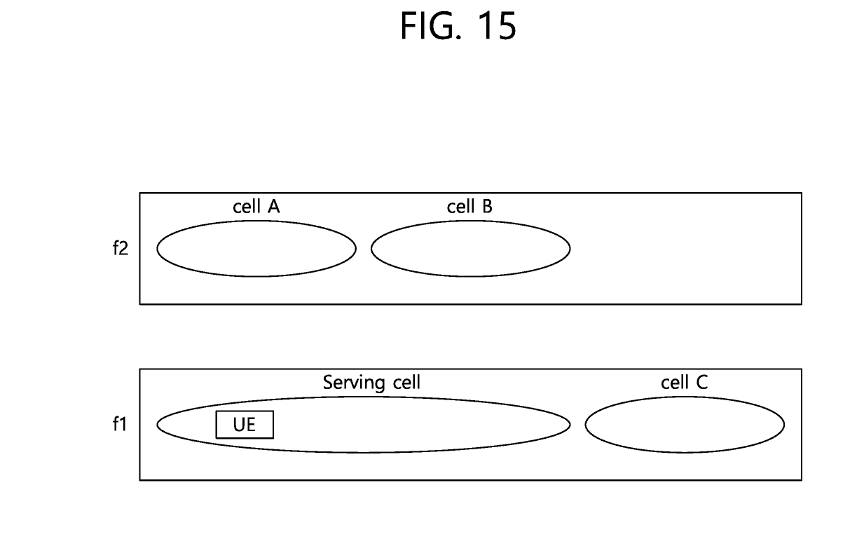

FIG. 15 illustrates one example in which the UE transmits the discovery signal in a future wireless communication system.

Referring to FIG. 15, f1 represents a serving frequency for the UE and f2 represents a non-serving frequency for respect to the UE.

The serving cell for the UE and a cell C which is a non-serving cell for the UE may exist in the serving frequency f1. Cells A and B which are the non-serving cells for the UE may exist in the non-serving frequency f2.

In the related art, it is assumed that the UE transmits the discovery signal in only the serving cell, but in the future wireless communication system, it is assumed that the UE may transmit the discovery even in other cells other than the serving cell. For example, the UE may transmit the discovery signal in cell C which is the non-serving cell in the serving frequency or transmit in the cell A or B which is the non-serving cell in the non-serving frequency.

Herein, transmitting the discovery signal in cell A by the UE may mean transmitting the discovery signal by applying ‘parameters for transmitting the discovery signal’ configured with respect to cell A.

As described above, when the sidelink UE information in the related art is similarly applied to the future wireless communication system in which the discovery signal may be transmitted by various methods, system efficiency deteriorates. For example, when a specific UE intends to transmit the discovery signal in other cells instead of the serving cell (primary cell) thereof, the network may need to enable transmitting the discovery signal without scheduling uplink signal transmission by cellular communication in the other cells to the specific UE. However, when the UE does not provide information on the other cell to the network, the network may not perform scheduling considering the UE that intends to transmit the discovery signal.

A method that may solve the problem is described.

When the UE enters an RRC connection state, the UE may transmit the sidelink UE information to the base station. The sidelink UE information may include a list of frequencies in which the UE is interested in transmitting (announcing)/receiving/or transceiving the discovery signal. The frequencies included in the list may include the serving frequency and the non-serving frequency of the UE.

Meanwhile, the UE may 1) be interested in transmitting the discovery signal in the serving frequency and 2) be interested in transmitting the discovery signal in the non-serving frequency. The UE may operate as follows with respect to each of two cases described above.

First, when the UE is interested in transmitting the discovery signal in not a primary serving frequency but a secondary serving frequency, the UE may transmit the discovery signal by using the ProSe configuration corresponding to the corresponding secondary cell. In order to announce that the UE is interested in transmitting the discovery signal and request a transmission resource to be used for transmitting the discovery signal, the UE may perform one of the following operations with respect to the network.

The UE may announce a serving cell index configured in the serving frequency targeted into the sidelink UE information or announce the frequency of the serving cell as a part of a ‘transmission resource request’ of requesting the transmission resource for transmitting the discovery signal. In this case, a cell selected through cell selection/reselection in the frequency in which the UE intends to transmit the discovery signal corresponds to the serving cell (that is, SCell).

The targeted frequency of the non-serving cell and a physical cell ID of the non-serving cell are included in the sidelink UE information to be transmitted to the network. That is, a frequency in which the non-serving cell to which the UE intends to transmit the discovery signal is positioned and an ID of the non-serving cell are included in the sidelink UE information and transmitted to the network. In this case, the cell selected through the cell selection/reselection in the frequency in which the UE intends to transmit the discovery signal corresponds to the non-serving cell.

Alternatively, the UE may announce a global cell ID of the cell to which the UE intends to transmit the discovery signal to the network.

Next, the UE may be interested in transmitting the discovery signal in the non-serving frequency. That is, the UE may intend to announce the discovery signal in the non-serving frequency. In this case, the UE may transmit the discovery signal by using the ProSe configuration corresponding to the cell selected for the ProSe operation (that is, transmission of the discovery signal) in the non-serving frequency.

The UE may operate as follows in order to announce that the UE is interested in transmitting the discovery signal and request the resource for transmitting the discovery signal.

The UE may announce to the network both the frequency of the non-serving cell in which the UE intends to transmit the discovery signal and the physical cell ID of the non-serving cell. That is, the frequency in which the non-serving cell to which the UE intends to transmit the discovery signal is positioned and the ID of the non-serving cell are included in the sidelink UE information and transmitted to the network.

Alternatively, the UE may announce the global cell ID of a targeted cell positioned in the frequency in which the UE intends to transmit the discovery signal.

By the aforementioned method, the UE decides a cell in which the UE intends to perform the ProSe operation and announces information to identify the cell to the network. In this case, the cell may be a cell positioned in a non-primary frequency for the UE. When the cell is the secondary serving cell, the information to identify the cell may be the serving cell index or physical cell identity (ID) of the cell. When the cell is the non-serving cell, the information to identify the cell may be constituted by the frequency of the cell and the physical cell identity (ID) of the cell.

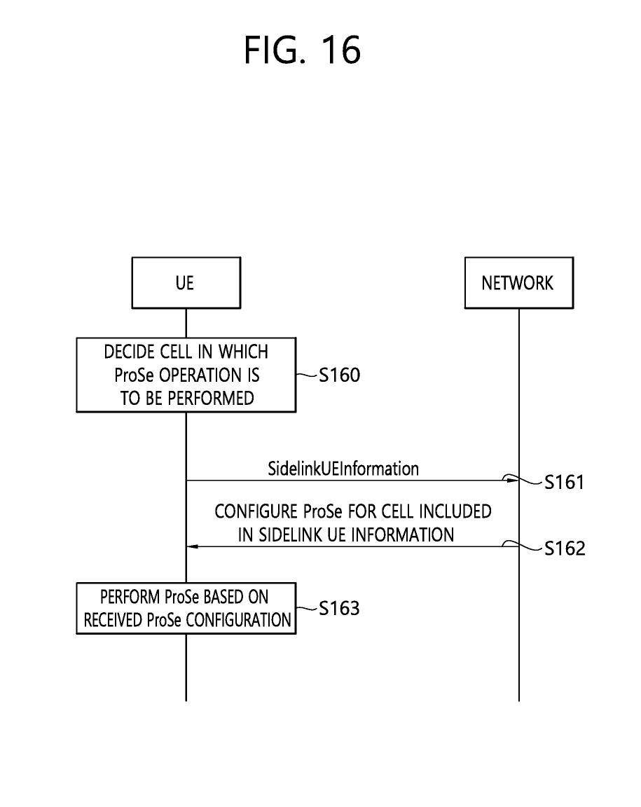

FIG. 16 illustrates a method for transmitting sidelink UE information of a UE according to an embodiment of the present invention.

Referring to FIG. 16, the UE decides the cell in which the UE intends to perform the ProSe operation (S160). As described above, the cell may be the non-serving cell positioned in the non-serving frequency for the UE and the non-serving cell positioned in the serving frequency for the UE.

The UE transmits the sidelink UE information to the network (S161).

Information included in the sidelink UE information has been described above. For example, when the sidelink UE information includes the frequency of the non-serving cell and the physical cell ID of the non-serving cell in which the UE intends to transmit the discovery signal, the sidelink UE information may be configured as below.

TABLE 3
-- ASN1START

| | |
|---|---|
| SidelinkUEInformation-r13 ::= | SEQUENCE { |
| criticalExtensions | CHOICE { |
| c1 | CHOICE { |
| sidelinkUEInformation-r13 | SidelinkUEInformation-r13- |
| IEs, | |

```
    spare3 NULL, spare2 NULL, spare1 NULL
    },
```

| | |
|---|---|
| criticalExtensionsFuture | SEQUENCE { } |
| } | |
| } | |
| SidelinkUEInformation-r13-IEs ::= | SEQUENCE { |
| commRxInterestedFreq-r13 | ARFCN-ValueEUTRA-r9 |
| OPTIONAL, | |
| commTxResourceReq-r13 | SL-CommTxResourceReq- |
| r13 OPTIONAL, | |
| discRxInterest-r13 | ENUMERATED {true} |
| OPTIONAL, | |
| discTxResourceReq-r13 | INTEGER (1..63) |
| OPTIONAL, | |
| discTxInterestFreq-r13 | |
| lateNonCriticalExtension | OCTET STRING |
| OPTIONAL, | |
| nonCriticalExtension | SEQUENCE { } |
| OPTIONAL | |
| } | |
| discTxInterestFreq-r13::= | SEQUENCE { |
| carrierFreq-r13 | ARFCN-ValueEUTRA-r9 |
| PhysicalCellID | |
| } | |
| SL-CommTxResourceReq-r13 ::= | SEQUENCE { |
| carrierFreq-r13 | ARFCN-ValueEUTRA-r9 |
| OPTIONAL, | |
| destinationInfoList-r13 | SL-DestinationInfoList-r13 |
| } | |

SL-DestinationInfoList-r13 ::= SEQUENCE (SIZE (1..maxSL-Dest-r13))
OF SL-DestinationIdentity-r13
SL-DestinationIdentity-r13 ::= BIT STRING (SIZE (24))
-- ASN1STOP

In Table 3, ‘discTxInterestFreq’ represents the frequency of the non-serving cell and the physical cell ID of the non-serving cell in which the UE intends to transmit the discovery signal.

In Table 3, only a case where one ‘discTxInterestFreq’ is included is exemplified, but the present invention is not limited thereto and a plurality of ‘discTxInterestFreq's may be included in the form of the list.

The network provides the ProSe configuration for the cell included in the sidelink UE information to the UE (S162). For example, when the UE announces that the non-serving cell in which the UE is interested in transmitting the discovery signal is cell B and the corresponding frequency is f2 through the sidelink UE information, the network announces to the UE parameters (configurations) for transmitting the discovery signal, which is configured with respect to cell B. When cells A and B exist in the f2, since ‘the parameters (configurations) for transmitting the discovery signal’ for cell A need not be announced, signaling overhead is reduced.

The UE performs the ProSe operation based on a received ProSe configuration (S163). In the example, transmitting the discovery signal by the UE becomes one example of the ProSe operation.

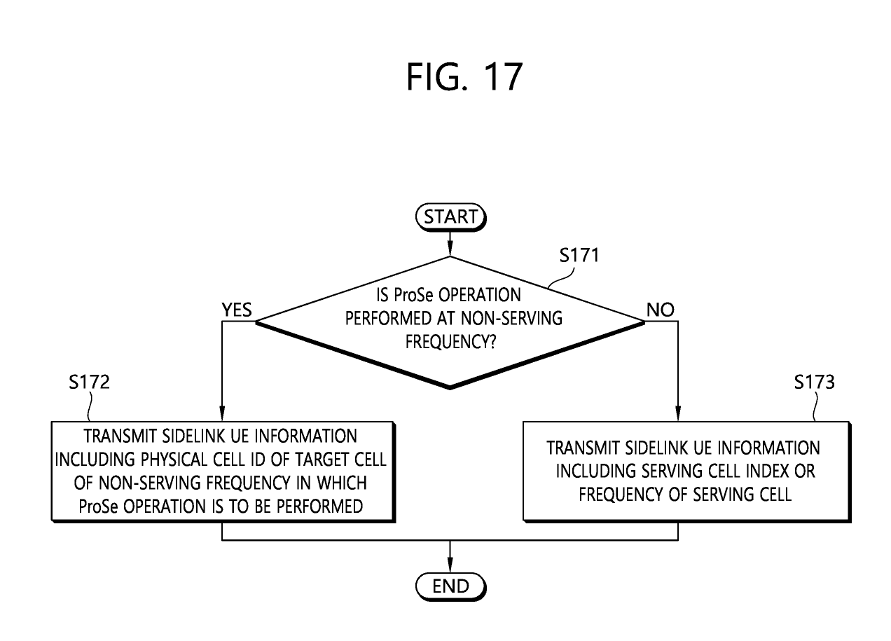

FIG. 17 illustrates a method for transmitting sidelink UE information of a UE according to an embodiment of the present invention.

The UE determines whether to perform the ProSe operation (e.g., transmission of the discovery signal) in the non-serving frequency (S171).

When the UE intends to perform the ProSe operation in the non-serving frequency, the UE transmits to the network the sidelink UE information including the physical cell ID of the target cell of the non-serving frequency to perform the ProSe operation (S172). The sidelink UE information may include even information for announcing the frequency of the target cell together with the physical cell ID of the target cell of the non-serving frequency.

On the contrary, when the UE intends to perform the ProSe operation in the serving frequency, the UE transmits to the network the sidelink UE information including the serving cell index (ID) or the frequency of the serving cell (S173). The serving cell index (ID) may be transmitted as a part as (that is, while being included in) the ‘transmission resource request’ of requesting the resource for transmitting the discovery signal. By such a method, when the UE intends to perform the ProSe operation in the serving frequency, since only the information for announcing the serving cell index or the frequency of the serving cell are included in the sidelink UE information, the signaling overhead may be reduced.

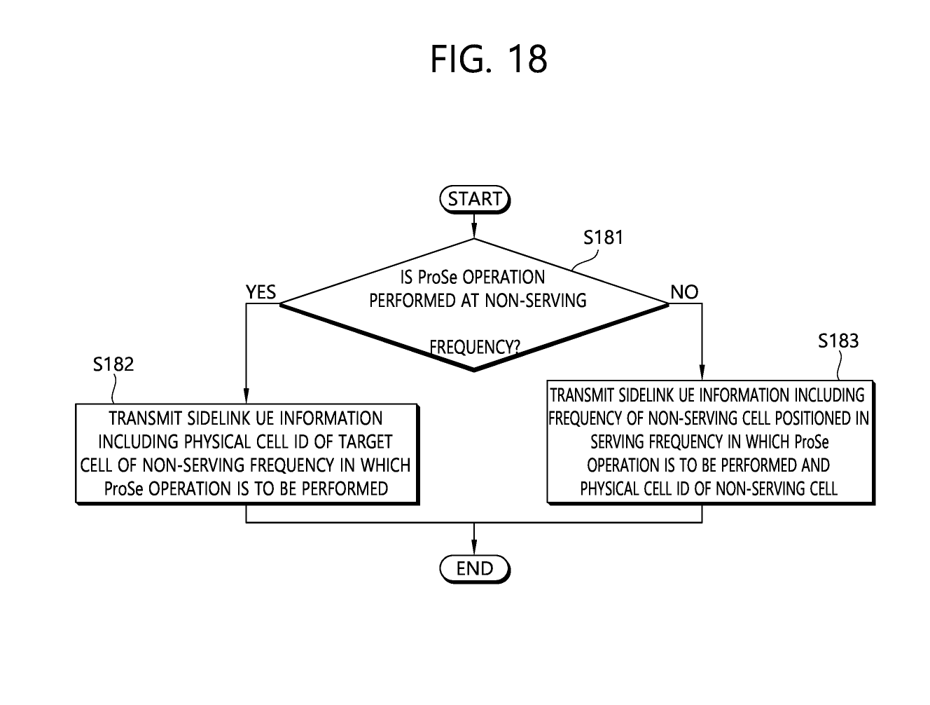

FIG. 18 illustrates a method for transmitting sidelink UE information of a UE according to another embodiment of the present invention.

The UE determines whether to perform the ProSe operation (e.g., transmission of the discovery signal) in the non-serving frequency (S181).

When the UE intends to perform the ProSe operation in the non-serving frequency, the UE transmits to the network the sidelink UE information including the physical cell ID of the target cell of the non-serving frequency to perform the ProSe operation (S182). The sidelink UE information may include even the information for announcing the frequency of the target cell together with the physical cell ID of the target cell of the non-serving frequency. This is similar to FIG. 17.

On the contrary, when the UE intends to perform the ProSe operation in the serving frequency, the UE transmits to the network the sidelink UE information including the frequency of the non-serving cell positioned in the serving frequency to perform the ProSe operation and the physical cell ID of the non-serving cell (S183). This process is a part differentiated from FIG. 17.

When signaling both the frequency of the non-serving cell and the physical cell ID of the non-serving cell and signaling only an index (alternatively, the frequency of the serving cell) of the serving cell are not large in difference of overhead, it may be preferable to use the method disclosed in FIG. 18. The reason is that since the UE may signal the sidelink UE information of the same type regardless of in which frequency the UE intends to transmit the discovery signal, complexity is reduced.

Meanwhile, when a new cell to be used for ProSe is selected while the UE already announces the cell selected for the ProSe operation, the UE may trigger the operation of transmitting the sidelink UE information to the network.

The UE may announce that the cell selected for the ProSe operation is changed to the network through the sidelink UE information. The UE may announce the selected new cell to the network.

The UE suspends the ProSe operation when the resource corresponding to the selected new cell is not usable. When the resource corresponding to the selected new cell is usable, the UE performs the ProSe operation by using the resource corresponding to the selected new cell.

The UE performs in-frequency cell reselection in the frequency in which the UE is interested in transmitting the signal depending on the ProSe operation to select the new cell in the same frequency. When the UE already announces the cell selected for the ProSe operation to the network and is not interested in the ProSe operation even in any cell of a specific frequency in which the selected cell is positioned, the UE may announce that the UE is not interested in transmitting the discovery signal in the cell any longer to the network through the sidelink UE information. In this case, the UE may delete the specific frequency in the list of the frequencies in which the UE is interested in transmitting the discovery signal.

When the base station receives the sidelink UE information for announcing that the UE is interested in transmitting the ProSe from the UE, if the base station knows transmission resource pool parameters for the cell of the frequency, which announce that the UE is interested in transmitting the discovery signal, the base station may signal the transmission resource pool parameters to the UE. In this case, the UE may transmit the discovery signal in another frequency by using the transmission resource pool parameter.

That is, the base station may transmit the transmission resource pool parameter configured with respect to the cell of the frequency in which the UE is interested in the ProSe operation through a dedicated signal for the UE as auxiliary information for the UE.

When the base station may not know the transmission resource pool parameter for the cell of another frequency in which the UE is interested in transmitting the discovery signal, the base station may not consider transmission of the discovery signal in the another frequency in uplink scheduling for the UE. In this case, whenever the uplink scheduling by the cellular communication overlaps with the transmission of the discovery signal, the UE may need to drop the transmission of the discovery signal based on a principle to prioritize the cellular communication. However, when the UE operates as such, performance of a D2D discovery operation in the another frequency may be degraded.

When the base station receives the sidelink UE information for announcing that the UE is not interested in the ProSe operation (e.g., ProSe transmission) in a specific frequency any longer from the UE, the base station may perform scheduling without considering the ProSe operation in the specific frequency.

Meanwhile, the UE may report to the network the transmission resource pool parameter corresponding to the cell of the frequency in which the UE is interested in transmitting the discovery signal. For example, it is assumed that the UE having cell 1 positioned in the f1 frequency as the serving cell is interested in transmitting the discovery signal in cell 2 of the f2 frequency. In this case, in the case where the UE regards that cell 1 may not know a transmission resource pool of cell 2, when the UE requests the transmission resource for transmitting the discovery signal to cell 1, the UE may report the transmission resource pool of cell 2. The UE may report the transmission resource pool of cell 2 to cell 1 through the sidelink UE information.

In the present invention, a D2D discovery signal is described, but the present invention may be applied even to the D2D communication.

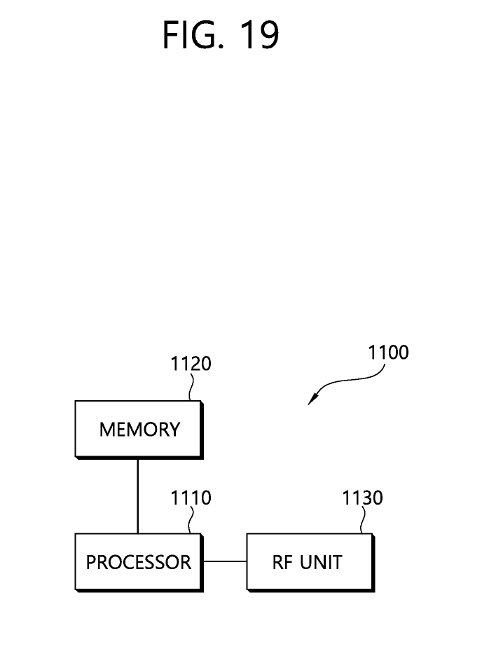

FIG. 19 is a block diagram illustrating a UE in which the embodiment of the present invention is implemented.

Referring to FIG. 19, the UE 1100 includes a processor 1110, a memory 1120, and a radio frequency (RF) unit 1130. The processor 1110 implements a function, a process, and/or a method which are proposed. The RF unit 1130 is connected with the processor 1110 to transmit and receive a radio signal.

The processor may include an application-specific integrated circuit (ASIC), another chipset, a logic circuit and/or a data processing apparatus. The memory may include a read-only memory (ROM), a random access memory (RAM), a flash memory, a memory card, a storage medium, and/or other storage devices. The RF unit may include a baseband circuit for processing the radio signal. When the embodiment is implemented by software, the aforementioned technique may be implemented by a module (a process, a function, and the like) that performs the aforementioned function. The module may be stored in the memory and executed by the processor. The memory may be positioned inside or outside the processor and connected with the processor by various well-known means.

What is claimed is:

1. A method for transmitting sidelink UE information of a UE in a wireless communication system, the method comprising:
deciding a cell which intends to perform a proximity based services (ProSe) operation; and
transmitting sidelink UE information including information to identify the cell to a network.

2. The method of claim 1, wherein the cell is a cell positioned in a non-primary frequency for the UE.

3. The method of claim 1, wherein when the cell is a secondary serving cell, the information to identify the cell is a serving cell index or a physical cell identity (ID) of the cell.

4. The method of claim 1, wherein when the cell is a non-serving cell, the information to identify the cell is constituted by a frequency of the cell and the physical cell identity (ID) of the cell.

5. The method of claim 1, wherein when the cell which intends to perform the ProSe operation is the non-serving cell positioned in the non-serving frequency for the UE, the UE transmits information for announcing the frequency of the non-serving cell and the physical cell ID of the non-serving cell included in the sidelink UE information.

6. The method of claim 5, wherein when the cell which intends to perform the ProSe operation is the non-serving cell positioned in the serving frequency for the UE, the UE transmits information for announcing the frequency of the serving cell and the physical cell ID of the non-serving cell included in the sidelink UE information.

7. The method of claim 5, wherein when the cell which intends to perform the ProSe operation is the non-serving cell positioned in the serving frequency for the UE, the UE transmits the information for announcing the frequency of the serving cell or the physical cell ID of the non-serving cell included in the sidelink UE information.

8. The method of claim 1, wherein a ProSe configuration for the cell is received from the network.

9. The method of claim 8, wherein the UE performs the ProSe operation based on the ProSe configuration.

10. A user equipment (UE) comprising:
a radio frequency (RF) unit transmitting and receiving a radio signal; and
a processor operated in association with the RF unit,
wherein the processor
decide a cell in which the UE intends to perform a proximity based services (ProSe) operation, and
transmits sidelink UE information including information to identify the cell to a network.
